(19) United States
(12) Patent Application Publication
(10) Pub. No.: US 2019/0368434 A1
(43) Pub. Date: Dec. 5, 2019

(54) PUMP MODULE AND EVAPORATED FUEL PROCESSING DEVICE

(71) Applicant: AISAN KOGYO KABUSHIKI KAISHA, Obu-shi, Aichi (JP)

(72) Inventor: Daisaku ASANUMA, Gamagori-shi (JP)

(21) Appl. No.: 16/463,104

(22) PCT Filed: Oct. 10, 2017
(86) PCT No.: PCT/JP2017/036685

§ 371 Date: May 22, 2019

(30) Foreign Application Priority Data
Nov. 24, 2016 (JP) 2016-228301

(51) Int. Cl. F02D 41/00; F02M 25/08

(52) U.S. Cl. CPC F02D 41/0045; F02M 25/0836; F02M 25/089

(57) ABSTRACT

A pump module mounted in an evaporated fuel processing device may include: a pump pumping evaporated fuel in a purge passage to an intake passage; and a pump controller controlling drive of the pump. The pump controller may be communicably connected with a main controller configured to control an engine, and, configured to: perform, by using a characteristic of the pump, at least one process of a concentration detecting process and a normality determining process, the concentration detecting process being a process of detecting a concentration of the evaporated fuel in gas within the pump, and the normality determining process being a process of determining whether the pump is being driven normally or not; and send a process result of the at least one process to the main controller.

### TECHNICAL FIELD

The disclosure herein relates to an evaporated fuel processing device mounted in a vehicle, and a pump module of the evaporated fuel processing device.

### BACKGROUND ART

Patent Document 1 describes an evaporated fuel processing device configured to supply evaporated fuel in a fuel tank to an intake passage of an engine. The evaporated fuel processing device is provided with a canister adsorbing the evaporated fuel, a control valve disposed on a purge-air pipe between the canister and the intake passage, and an air pump pumping air to the purge-air pipe. The control valve and the pump are controlled by a fuel-supply-system control unit. The fuel-supply-system control unit is configured to be communicable with a host-system control unit. The fuel-supply-system control unit further controls a fuel pump supplying fuel in the fuel tank to the engine, and a fuel level gauge inside the fuel tank.

### PRIOR ART DOCUMENT

### Patent Document

### PATENT DOCUMENT 1: Japanese Patent Application Publication No. 2005-188448

### SUMMARY

### Technical Problem

In the above evaporated fuel processing device, no consideration is given to determining whether or not the air pump is being driven normally and to specifying a concentration of the evaporated fuel.

The disclosure herein provides a technique for performing at least one of determination whether or not a pump is being driven normally and specification of a concentration of evaporated fuel in gas by using the pump.

### Solution to Technical Problem

A technique disclosed herein relates to a pump module. The pump module is mounted in an evaporated fuel processing device configured to perform a purge process in which evaporated fuel in a fuel tank is supplied to an intake passage of an engine through a purge passage. The pump module may comprise: a pump configured to pump the evaporated fuel in the purge passage to the intake passage; and a pump controller configured to control drive of the pump. The pump controller may be communicably connected with a main controller configured to control the engine. The pump controller may be configured to: perform, by using a characteristic of the pump, at least one process of a concentration detecting process and a normality determining process, the concentration detecting process being a process of detecting a concentration of the evaporated fuel in gas within the pump, and the normality determining process being a process of determining whether the pump is being driven normally or not; and send a process result of the at least one process to the main controller.

In this configuration, the pump controller, which is provided separately from the main controller, performs the concentration detecting process and/or the normality determining process by using the characteristic of the pump. In this configuration, as compared to a configuration in which the main controller performs the concentration detecting process and/or the normality determining process, the pump controller does not have to send the characteristic of the pump to the main controller. As a result, processing load on the main controller may be reduced.

The pump controller may be configured to perform communication with the main controller by using a PWM signal based on pulse-width modulation. Here, in a case where a PWM signal having a first duty cycle is received from the main controller, the pump controller may drive the pump at a rotational speed corresponding to the first duty cycle, the first duty cycle being within a first range. Further, in a case where a PWM signal having a second duty cycle is received from the main controller, the pump controller may drive the pump at a predetermined rotational speed and perform the at least one process, the second duty cycle being out of the first range. According to this configuration, as compared to a case where the main controller and the pump controller perform communication according to a Controller Area Network (CAN) standard or a Local Interconnect Network (LIN) standard, a circuit configuration which the pump controller comprises may be simplified. Further, by changing the duty cycle of the PWM signal, the main controller may cause the pump controller to control the rotational speed of the pump.

The pump controller may be configured to send to the main controller a PWM signal having a duty cycle that indicates the process result. According to this configuration, the pump controller may supply the process result to the main controller by using the PWM signal.

A technique disclosed herein relates to an evaporated fuel processing device that comprises any of the pump modules as described above. The evaporated fuel processing device is mounted in a vehicle and may comprise: the pump module as in any one of the aforementioned; a canister configured to store evaporated fuel: a control valve disposed on the purge passage communicating between the canister and the intake passage of the engine and configured to switch between a closed state in which the purge passage is closed and an open state in which the purge passage is opened; and a valve controller configured to control the control valve and communicably connected with the pump controller.

In this configuration, the pump controller, which is provided separately from the main controller, performs the concentration detecting process and/or the normality determining process by using the characteristic of the pump. In this configuration, as compared to the configuration in which the main controller performs the concentration detecting process and/or the normality determining process, the pump controller does not have to send the characteristic of the pump to the main controller. As a result, the processing load on the main controller may be reduced.

The valve controller may be configured to perform the purge process by continuously switching the control valve between the closed state and the open state. While the purge process is performed and the at least one process is not performed, the valve controller may switch the control valve with a ratio equal to or less than a first upper value, wherein the ratio is a ratio of a duration for one open state to a total duration for the one open state and one closed state. Further, while the purge process is performed and the at least one process is preformed, the valve controller may switch the control valve with a ratio equal to or less than a second upper value, wherein the ratio is a ratio of a duration for one open state to a total duration for the one open state and one closed state, and the second upper value is less than the first upper value. The pump controller may be configured to perform the at least one process by using the characteristic of the pump while the control valve is in the closed state. While the control valve is continuously switched between the closed state and the open state, the characteristic of the pump may also switch in accordance with the switch of the control valve between the closed state and the open state. In the above configuration, a duration in which the control valve is maintained in the open state is restricted while the at least one process is performed. In other words, a duration in which the control valve is maintained in the closed state may be made long. As a result, when the characteristic of the pump has changed accompanying the switch of the control valve from the open state to the closed state, the characteristic of the pump while the control valve is in the closed state may be stabilized. Due to this, a more accurate process result may be acquired by using the stabilized characteristic of the pump.

The valve controller may be configured to prohibit switching the control valve to the closed state while the purge process is not performed, the closed state is maintained, and the at least one process is performed. According to this configuration, the characteristic of the pump may be prevented from changing due to the control valve being switched from the closed state to the open state in middle of the process.

### BRIEF DESCRIPTION OF DRAWINGS

FIG. 1 shows an overview of a fuel supply system in a vehicle.

FIG. 2 shows a rotational speed-duty cycle data map according to a first embodiment.

FIG. 3 shows a flowchart of a concentration acquiring process performed by a controller according to the first embodiment.

FIG. 4 shows a flowchart of a concentration detecting process performed by a pump controller according to the first embodiment.

FIG. 5 shows a flowchart continued from FIG. 4.

FIG. 6 shows a timing chart for respective units controlled by the controller and the pump controller in the concentration acquiring process and the concentration acquiring process.

FIG. 7 shows a flowchart of a determination acquiring process performed by a controller according to a second embodiment.

FIG. 8 shows a flowchart of a normality determining process performed by the controller according to the second embodiment.

FIG. 9 shows a flowchart continued from FIG. 8.

### DESCRIPTION OF EMBODIMENTS

### First Embodiment

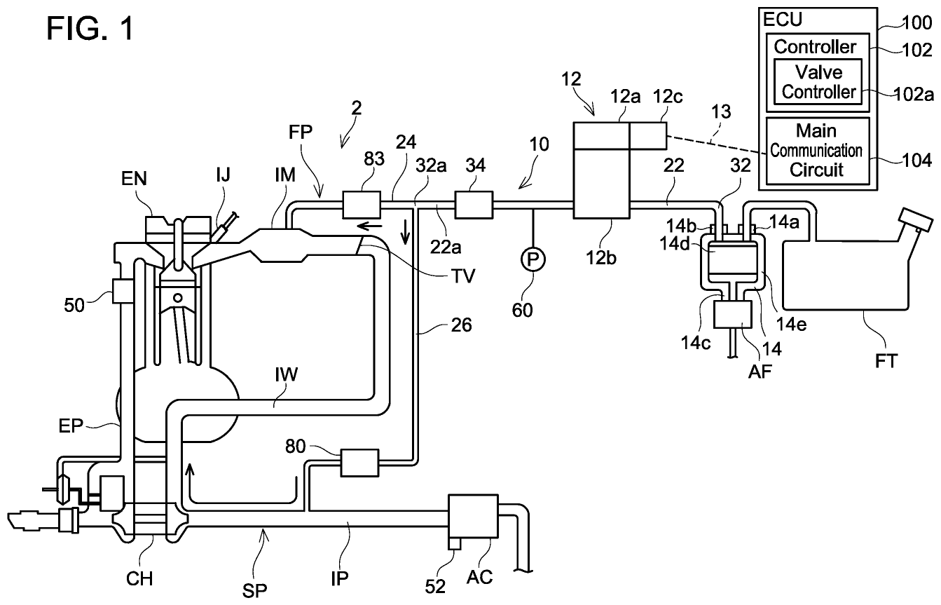

An evaporated fuel processing device 10 will be described with reference to the drawings. As shown in FIG. 1, the evaporated fuel processing device 10 is mounted in a vehicle such as an automobile, and is disposed in a fuel supply system 2 configured to supply fuel stored in a fuel tank FT to an engine EN.

The fuel supply system 2 is configured to supply the fuel pumped by a fuel pump (not shown) housed in the fuel tank FT to an injector IJ. The injector IJ includes a solenoid valve of which divergence is adjusted by an Engine Control Unit (ECU) 100 to be described later. The injector IJ is configured to supply the fuel to the engine EN.

An intake pipe IP and an exhaust pipe EP are connected to the engine EN. The intake pipe IP is a pipe to supply air to the engine EN by a negative pressure of the engine EN or by an operation of a supercharger CH. The intake pipe IP defines an intake passage IW. The intake passage IW has a throttle valve TV disposed thereon. The throttle valve TV is configured to adjust a divergence of the intake passage IW to control an amount of air flowing into the engine EN. The throttle valve TV is controlled by the ECU 100. The supercharger CH is disposed on the intake passage IW on an upstream side relative to the throttle valve TV. The supercharger CH is a so-called turbo charger, and is configured to rotate a turbine by gas discharged from the engine EN to the exhaust pipe EP to compress air in the intake passage IW and supply the same to the engine EN. The supercharger CH is controlled by the ECU 100.

An air cleaner AC is disposed on the intake passage IW on an upstream side relative to the supercharger CH. The air cleaner AC includes a filter that removes foreign matter from air flowing into the intake passage IW. In the intake passage IW, when the throttle valve TV opens, air is suctioned through the air cleaner AC toward the engine EN. The engine EN combusts the fuel and the air therein and discharges exhaust gas to the exhaust pipe EP after the combustion.

In a situation where the supercharger CH is not operating, a negative pressure is generated in the intake passage IW by drive of the engine EN. A situation may be raised in which the negative pressure in the intake passage IW is small, by the drive of the engine EN. Further, in a situation where the supercharger CH is operating, the upstream side relative to the supercharger CH has an atmospheric pressure, while a positive pressure is generated on a downstream side relative to the supercharger CH.

The evaporated fuel processing device 10 is configured to supply evaporated fuel in the fuel tank FT to the engine EN through the intake passage IW. The evaporated fuel processing device 10 includes a canister 14, a pump module 12, a purge pipe 32, a control valve 34, a controller 102 in the ECU 100, check valves 80, 83, and a pressure sensor 60. The canister 14 is configured to adsorb the evaporated fuel generated in the fuel tank FT. The canister 14 includes activated charcoal 14d and a case 14e housing the activated charcoal 14d. The case 14e includes a tank port 14a, a purge port 14b, and an air port 14c. The tank port 14a is connected to an upper end of the fuel tank FT. Due to this, the evaporated fuel in the fuel tank FT flows into the canister 14. The activated charcoal 14d is configured to adsorb the evaporated fuel from the gas flowing into the case 14e from the fuel tank FT. Due to this, the evaporated fuel can be suppressed from being discharged to open air.

The air port 14c communicates with open air through an air filter AF. The air filter AF removes foreign matter from air that flows into the canister 14 through the air port 14c.

The purge pipe 32 communicates with the purge port 14b. Mixed gas of the evaporated fuel in the canister 14 and air (hereinbelow termed “purge gas”) flows from the canister 14 into the purge pipe 32 through the purge port 14b. The purge pipe 32 defines purge passages 22, 24, 26. The purge gas in the purge pipe 32 flows through the purge passages 22, 24, 26 and is supplied to the intake passage IW.

The purge pipe 32 branches into two at a branching position 32a located between the canister 14 and the intake passage IW. One branch of the purge pipe 32 is connected to an intake manifold IM on an engine EN side (that is, on a downstream side) relative to the throttle valve TV and the supercharger CH, and the other branch of the purge pipe 32 is connected to an air cleaner AC side (that is, on an upstream side) relative to the throttle valve TV and the supercharger CH. The purge passage 22 is defined by the purge pipe 32 on a canister 14 side relative to the branching position 32a, the purge passage 24 is defined by the purge pipe 32 connected to the intake pipe IP on the downstream side relative to the branching position 32a of the purge pipe 32, and the purge passage 26 is defined by the purge pipe 32 connected to the intake pipe IP on the upstream side relative to the branching position 32a of the purge pipe 32.

The pump module 12 is disposed at an intermediate position on the purge passage 22. The pump module 12 includes a pump 12b and a pump controller 12a. The pump 12b is a so-called vortex pump (also called cascade pump or Wesco pump), or a centrifugal pump. The pump controller 12a is configured to control the pump 12b. The pump controller 12a includes a control circuit in which a CPU and a memory such as a ROM and a RAM are mounted.

The pump controller 12a is communicably connected with the ECU 100 via a wiring 13. The pump controller 12a includes a pump communication circuit 12c configured to communicate with the ECU 100 by using a PWM signal based on pulse-width modulation.

A discharge outlet of the pump 12b is communicated with the purge pipe 32. The pump 12b is configured to pump purge gas to the purge passage 22. The purge gas pumped to the purge passage 22 flows through the purge passage 24 or the purge passage 26 and is supplied to the intake passage IW.

The check valve 83 is disposed on the purge passage 24. The check valve 83 is configured to allow gas to flow in the purge passage 24 toward the intake passage IW and prohibit it to flow therein toward the canister 14. The check valve 80 is disposed on the purge passage 26. The check valve 80 is configured to allow gas to flow in the purge passage 26 toward the intake passage IW and prohibit it to flow therein toward the canister 14.

The control valve 34 is disposed on the purge passage 22 between the pump 12b and the branching position 32a. The control valve 34 is a solenoid valve controlled by the controller 102 in the ECU 100 and is controlled by the controller 102 to switch between an open state of being opened and a closed state of being closed. The controller 102 is configured to perform switching control of continuously switching between the open state and the closed state of the control valve 34 according to a divergence determined based on an air-fuel ratio and the like. In the open state, the purge passage 22 opens, by which the canister 14 and the intake passage IW are communicated. In the closed state, the purge passage 22 closes, by which communication between the canister 14 and the intake passage IW is cut off on the purge passage 22. The divergence indicates a ratio of a duration for one open state to a duration for one pair of one open state and one closed state that take place in succession to one another while the control valve is continuously switched between the open state and the closed state. The control valve 34 adjusts a flow rate of the gas containing the evaporated fuel (that is, the purge gas) by adjusting the divergence (that is, the duration for the open state). Further, a part of the purge passage 22 that is located downstream relative to the control valve 34 will be termed “purge passage 22a”.

The pressure sensor 60 is disposed on the purge passage 22 between the pump 12b and the control valve 34. The pressure sensor 60 is configured to detect a pressure in the purge passage 22. The pressure sensor 60 is controlled by the pump controller 12a.

The controller 102 is a part of the ECU 100 and is integrally disposed with other parts of the ECU 100 (such as a part for controlling the engine EN). The ECU 100 includes a CPU and a memory such as a ROM and a RAM. The ECU 100 is configured to control the engine EN. The ECU 100 is configured to perform PWM (abbreviation of Pulse Width Modulation (Pulse Width Modulation) communication with the pump communication circuit 12c of the pump controller 12a. The controller 102 refers to a part of the ECU 100 that especially controls the evaporated fuel processing device 10. The controller 102 controls the evaporated fuel processing device 10 according to a program stored in the memory in advance. Specifically, the controller 102 outputs a PWM signal to the pump controller 12a and controls a rotational speed of the pump 12b. Further, the controller 102 outputs a signal to the control valve 34 to switch it between the open and closed states. That is, the controller 102 is configured to adjust the divergence of the signal outputted to the control valve 34. Further, a part of the controller 102 that especially controls the control valve 34 may be termed “valve controller 102a”.

The ECU 100 is connected to an air-fuel ratio sensor 50 disposed in the exhaust pipe EP. The ECU 100 detects an air-fuel ratio in the exhaust pipe EP from a detection result of the air-fuel ratio sensor 50 and thereby controls a fuel injection amount from the injector IJ. Further, the ECU 100 is connected to an air flowmeter 52 disposed near the air cleaner AC. The air flowmeter 52 is a so-called hot-wire air flowmeter, however, it may have another configuration. The ECU 100 receives a signal indicating a detection result from the air flowmeter 52 and detects a gas amount (that is, an intake amount) suctioned to the engine EN.

Next, a purge process of supplying the purge gas from the canister 14 to the intake passage IW will be described. When the engine EN is driven and a purge condition is satisfied, the valve controller 102a of the controller 102 performs the switching control on the control valve 34 to perform the purge process. The purge condition is a condition that is satisfied in a case where the purge process of supplying the purge gas to the engine EN is to be performed, and is a condition set in the controller 102 by a manufacturer in advance based on a cooling water temperature for the engine EN and a specified situation of a purge concentration. During when the engine EN is being driven, the controller 102 monitors at all times whether the purge condition is satisfied.

In the purge process, the purge gas is supplied to at least one of the intake passage IW on the downstream side relative to the throttle valve TV from the canister 14 through the purge passages 22, 24 and the intake passage IW on the upstream side relative to the supercharger CH from the canister 14 through the purge passages 22, 26. Which one of the above passages is to be used for the supply changes depending on the pressure in the intake passage IW on the downstream side relative to the throttle valve TV.

In a case where the supercharger CH is not operating, the intake passage IW on the downstream side relative to the throttle valve TV has a negative pressure by the drive of the engine EN. On the other hand, the intake passage IW on the upstream side relative to the throttle valve TV is at a pressure substantially equal to an atmospheric pressure. As a result, the purge gas is primarily supplied from the canister 14 to the intake passage IW on the downstream side relative to the throttle valve TV (that is, into the intake manifold IM) through the purge passages 22, 24. A passage through which the purge gas is supplied from the control valve 34 to the engine EN through the purge passages 22a, 24 and the intake passage IW will be termed a first purge passage FP.

On the other hand, while the supercharger CH is operating, the air on the downstream side relative to the supercharger CH is compressed by the supercharger CH. Due to this, the pressure in the intake passage IW on the downstream side relative to the supercharger CH becomes higher than that on the upstream side relative to the supercharger CH. As a result, the purge gas is primarily supplied from the canister 14 to the intake passage IW on the upstream side relative to the supercharger CH through the purge passages 22, 26. The intake passage IW on the upstream side relative to the supercharger CH is at a pressure approximate to the atmospheric pressure, and a slight degree of negative pressure is generated by the supercharger CH. A passage through which the purge gas is supplied from the control valve 34 to the engine EN through the purge passages 22a, 26 and the intake passage IW will be termed a second purge passage SP. The second purge passage SP is longer than the first purge passage FP.

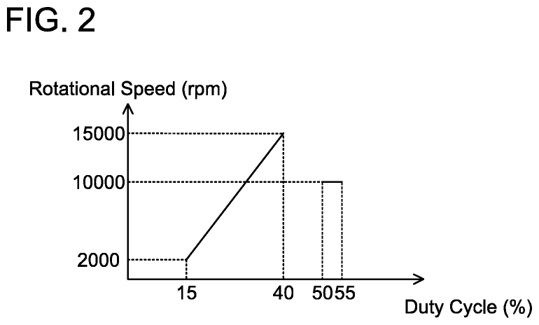

The controller 102 drives and stops the pump 12b according to a situation of the negative pressure in the intake passage IW (such as a rotational speed of the engine EN). Specifically, each of the controller 102 and the pump controller 12a stores a rotational speed-duty cycle data map shown in FIG. 2 that indicates corresponding relationships between duty cycles of PWM signals and rotational speeds of the pump 12b. A vertical axis of FIG. 2 indicates rotational speed (rpm) of the pump 12b, and a horizontal axis thereof indicates duty cycle (%) of PWM signal. In the rotational speed-duty cycle data map stored in each of the controller 102 and the pump controller 12a, the rotational speeds and the duty cycles are associated with one other in numerical values.

The controller 102 determines the rotational speed of the pump 12b according to the situation of the negative pressure in the intake passage IW (such as the rotational speed of the engine EN). The rotational speed of the pump 12b is determined, for example, within 2000 to 15000 rpm. The controller 102 specifies a duty cycle corresponding to the determined rotational speed from the rotational speed-duty cycle data map. Duty cycles corresponding to 2000 to 15000 rpm are, for example, 15% to 40%. That is, a range of duty cycles to be used in a normal purge process is preset. This range of duty cycles is an example of “first range”. The controller 102 sends a PWM signal of the specified duty cycle to the pump controller 12a.

A communication method between the controller 102 and the pump controller 12a will be described. The communication between the controller 102 and the pump controller 12a is performed between a main communication circuit 104 and the pump communication circuit 12c. For example, the controller 102 causes the main communication circuit 104 on the ECU 100 side to store the specified duty cycle corresponding to the rotational speed of the pump 12b. The main communication circuit 104 sends a PWM signal of the stored duty cycle to the pump communication circuit 12c periodically (for example, every 16 ms). Further, the main communication circuit 104 receives a PWM signal from the pump communication circuit 12c periodically (for example, every 16 ms). In other words, the pump communication circuit 12c receives a PWM signal from the main communication circuit 104 and sends a PWM signal thereto periodically.

When receiving a PWM signal from the controller 102, the pump controller 12a specifies a rotational speed corresponding to the duty cycle of the PWM signal from the rotational speed-duty cycle data map. Then, the pump controller 12a supplies to the pump 12b power for causing the pump 12b to rotate at the specified rotational speed. Due to this, the pump 12b is driven at the rotational speed determined by the controller 102.

While the purge process is performed, the engine EN is supplied with the fuel supplied through the injector IJ from the fuel tank FT and the evaporated fuel by the purge process. The controller 102 adjusts the air-fuel ratio of the engine EN to an optimal air-fuel ratio (such as an ideal air-fuel ratio) by adjusting the divergence of the injector 1.1 and the divergence of the control valve 34.

Due to this, it is desirable for the controller 102 to suitably keep track of an amount of the fuel supplied from the injector IJ to the engine EN and an amount of the fuel supplied to the engine EN by the purge process. The fuel supplied from the injector IJ to the engine EN is determined based on the divergence of the injector IJ. On the other hand, the fuel supplied by the purge process varies according to purge concentration.

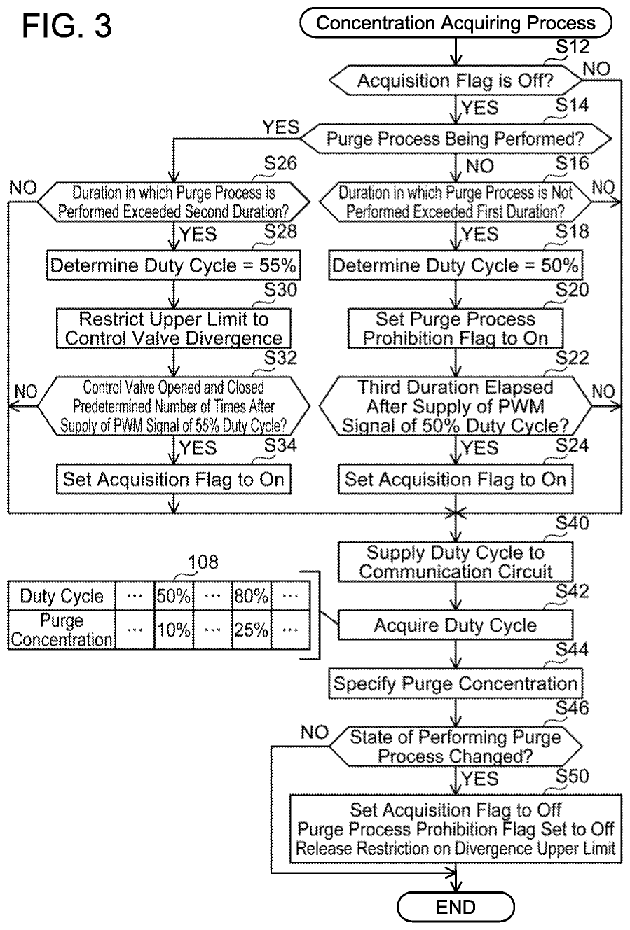

The controller 102 uses the pump module 12 to specify a purge concentration. FIG. 3 shows a flowchart of a concentration acquiring process which the controller 102 performs. When the vehicle is started (for example, when an ignition switch is turned on), the controller 102 performs the concentration acquiring process periodically (for example, every 16 ms). The controller 102 stores an acquisition flag and a purge process prohibition flag to be used in the concentration acquiring process. At the timing when the vehicle is started, the acquisition flag and the purge process prohibition flag are set to off.

In the concentration acquiring process, the controller 102 firstly determines in S12 whether or not the acquisition flag is off. In a case where the acquisition flag is on (NO in S12), the controller 102 proceeds to S40. On the other hand, in a case where the acquisition flag is off (YES in S12), the controller 102 determines in S14 whether or not the purge process is being performed. Specifically, the controller 102 determines whether or not the switching control is being performed on the control valve 34. In a case where the switching control is being performed, the controller 102 determines that the purge process is being performed (YES in S14). In a case where the switching control is not being performed, the controller 102 determines that the purge process is not being performed (NO in S14).

The controller 102 proceeds to S26 in the case of YES in S14, whereas it proceeds to S16 in the case of NO in S14. In S16, the controller 102 determines whether or not a duration in which the purge process is not performed has exceeded a first duration (for example, 500 ms). The first duration is a duration for the pressure in the purge passage 22 and the like to stabilize after a state where the purge process is being performed is switched to a state where it is not. The controller 102 includes a purge timer that measures the duration in which the purge process is being performed and the duration in which it is not performed. The controller 102 resets the purge timer and performs measurement each time the purge process is switched between being performed and not being performed. The controller 102 uses the purge timer to determine whether or not the duration in which the purge process is not performed has exceeded the first duration. In a case where the duration in which the purge process is not performed has not exceeded the first duration (NO in S16), the controller 102 proceeds to S40.

On the other hand, in a case where the duration in which the purge process is not performed has exceeded the first duration (YES in S16), the controller 102 determines a duty cycle of PWM signal to be sent to the pump controller 12a to be 50% in S18. As shown in FIG. 2, the duty cycle=50% is outside the range of the duty cycles for controlling the rotational speed of the pump 12b during the purge process (that is, the range of 15% to 40%). The duty cycle=50% is a signal indicating that a purge concentration is to be specified in the controller 102 and the pump controller 12a while the purge process is not performed. The duty cycle used in the process of S18 may take any value so long as it is outside the range of the duty cycles for controlling the rotational speed of the pump 12b during the purge process. The same applies to a duty cycle in S28 to be described later, and this duty cycle simply needs to differ from the duty cycle of S18.

Next, in S20, the controller 102 switches the purge prohibition flag from off to on. In a case where the purge prohibition flag is on, the controller 102 does not perform the purge process even when the purge condition is satisfied. Then, in S22, the controller 102 determines whether or not a third duration (for example, 300 ms) has elapsed since the duty cycle determined in S18 was supplied to the main communication circuit 104 in S40 to be described later. Although this will be described later, when the PWM signal of the duty cycle determined in S18 is received by the pump controller 12a, the rotational speed of the pump 12b may be changed. The third duration is a duration for the pressure in the purge passage 22 and the like to stabilize after the rotational speed of the pump 12b has been changed.

The controller 102 includes a first supply timer that measures a duration since the duty cycle determined in S18 was supplied to the main communication circuit 104 in S40. The controller 102 resets the first supply timer and performs measurement each time the duty cycle determined in S18 is supplied in S40. In S22, the controller 102 uses the first supply timer to determine whether or not the third duration has elapsed. In a case where the third duration has not elapsed (NO in S22), the controller 102 proceeds to S40. On the other hand, in a case where the third duration has elapsed (YES in S22), the controller 102 sets the acquisition flag to on in S24 and proceeds to S40.

In S26, the controller 102 uses the purge timer to determine whether or not a duration in which the purge process is being performed has exceeded a second duration (for example, 1,000 ms). The second duration is a duration for the pressure in the purge passage 22 and the like to stabilize after the state in which the purge process is not performed is switched to the state in which it is being performed. In a case where the duration in which the purge process is being performed has not exceeded the second duration (NO in S26), the controller 102 proceeds to S40.

On the other hand, in a case where the duration in which the purge process is being performed has exceeded the second duration (YES in S26), the controller 102 determines a duty cycle of PWM signal to be sent to the pump controller 12a to be 55% in S28. Duty cycle=55% indicates that a purge concentration is to be specified in the controller 102 and the pump controller 12a while the purge process is being performed.

Next, in S30, the controller 102 (more specifically, the valve controller 102a) restricts an upper limit of the divergence of the control valve 34. For example, the controller 102 restricts the upper limit of the divergence (that is, the ratio of the duration for one open state to the duration for one pair of the one open state and the closed state) to 40% although it is 90% in the normal purge process. Due to this, in the purge process, the duration for the open state of the control valve 34 can be suppressed from being long. Next, in S32, the controller 102 determines whether or not the switch of the control valve 34 between open and closed has been performed a predetermined number of times (for example, 5 times) since the duty cycle determined in S28 was supplied to the main communication circuit 104 in S40 to be described later. Although this will be described later, when the PWM signal of the duty cycle determined in S28 is received by the pump controller 12a, the rotational speed of the pump 12b may be changed. The predetermined number of times corresponds to a duration for the pressure in the purge passage 22 and the like to stabilize after the rotational speed of the pump 12b has been changed.

In S32, the controller 102 counts how many times the control valve 34 has been switched since the duty cycle determined in S18 was supplied to the main communication circuit 104. In a case where the switch has not been performed the predetermined number of times (NO in S32), the controller 102 proceeds to S40.

On the other hand, in a case where the switch has been performed the predetermined number of times (YES in S32), the controller 102 sets the acquisition flag to on in S34 and proceeds to S40.

In S40, the controller 102 supplies a duty cycle related to the rotational speed of the pump 12b to the main communication circuit 104. For example, in S40 that takes place immediately after the duty cycle had been determined in S18 or S28, the controller 102 supplies the duty cycle determined in S18 or S28 to the main communication circuit 104. On the other hand, in a case where neither S18 nor S28 was performed immediately before, the controller 102 supplies the duty cycle corresponding to the rotational speed of the pump 12b determined during the purge process to the main communication circuit 104. In a case where the purge process is not being performed, the pump 12b is not being driven. In this case, the controller 102 supplies a duty cycle corresponding to the rotational speed=0 to the main communication circuit 104.

When supplied with the duty cycle, the main communication circuit 104 stores it in the main communication circuit 104. Then, the main communication circuit 104 sends a PWM signal of the duty cycle stored in the main communication circuit 104 to the pump communication circuit 12c. Further, the main communication circuit 104 receives a PWM signal sent from the pump communication circuit 12c. When receiving the PWM signal, the main communication circuit 104 supplies the duty cycle of the received PWM signal to the controller 102.

Due to this, in S42, the controller 102 acquires the duty ratio from the main communication circuit 104. Then in S44, the controller 102 specifies a purge concentration from the acquired duty cycle. Specifically, the controller 102 stores a duty cycle-concentration data map 108 that indicates relationships of duty cycles of PWM signals and purge concentrations. The duty cycle-concentration data map 108 is stored in the controller 102 in advance. The controller 102 specifies a purge concentration corresponding to the duty cycle acquired in S42 from the duty cycle-concentration data map 108.

Next, in S46, the controller 102 determines whether or not the purge process has been switched between being performed and not being performed since a timing when the last concentration acquiring process was performed. In a case where the purge process has been switched between being performed and not being performed (YES in S46), in S50, the controller 102 sets the acquisition flag and the purge prohibition flag to off and clears restriction on the divergence upper limit of the control valve 34 set in S30, and terminates the concentration acquiring process. On the other hand, in a case where the purge process has not been switched between being performed and not being performed (NO in S46), the controller 102 skips S50 and terminates the concentration acquiring process.

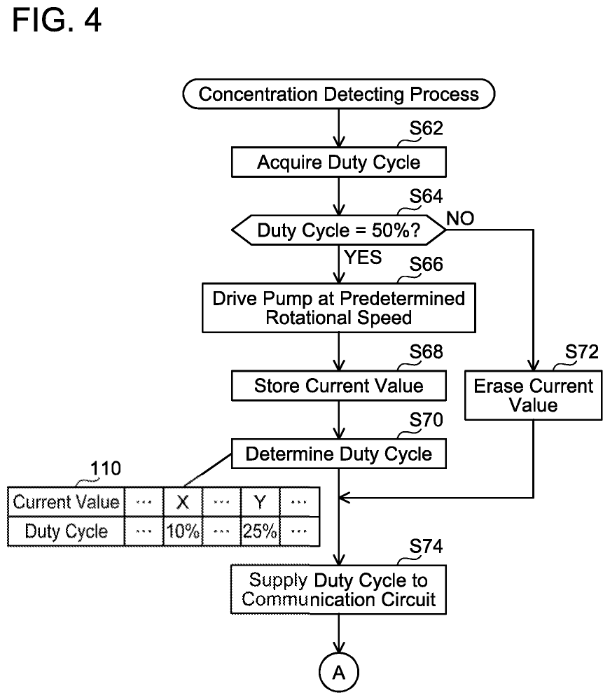

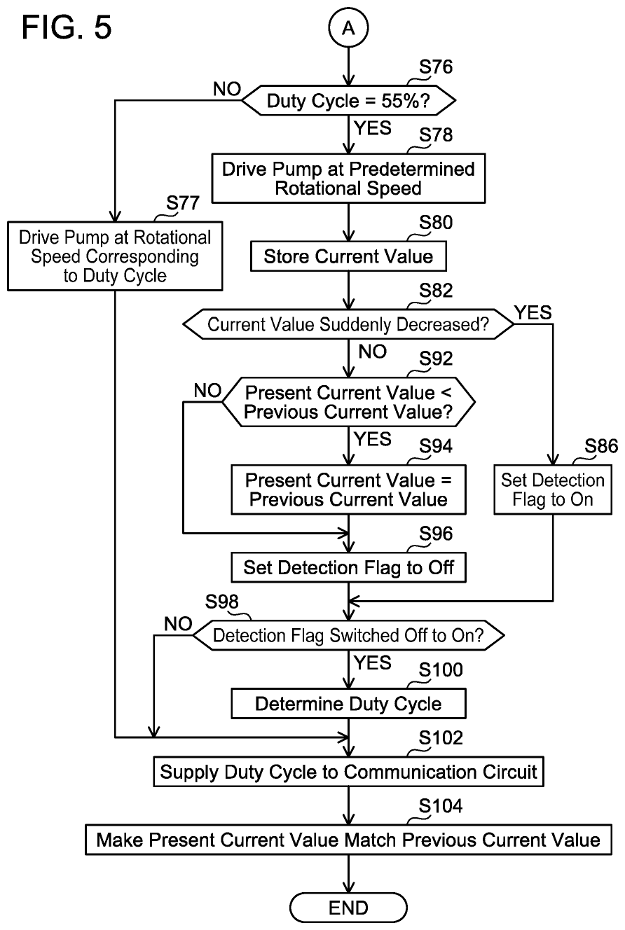

Next, a concentration detecting process which the pump controller 12a performs will be described with reference to FIGS. 4 and 5. When the vehicle is started, the pump controller 12a performs the concentration detecting process periodically (for example, every 2 ms). A frequency of the concentration detecting process is higher than a frequency of the concentration acquiring process which the controller 102 performs.

In S62, the pump controller 12a acquires from the pump communication circuit 12c the duty cycle of the PWM signal sent from the controller 102 via the main communication circuit 104.

The pump communication circuit 12c receives the PWM signal from the main communication circuit 104. The timing when the pump communication circuit 12c receives the PWM signal from the main communication circuit 104 corresponds to a timing when the main communication circuit 104 sends the PWM signal, thus it takes place periodically (for example, every 16 ms). When receiving the PWM signal from the main communication circuit 104, the pump communication circuit 12c stores the duty cycle of the received PWM signal. When receiving the PWM signal, the pump communication circuit 12c sends a PWM signal of the duty cycle stored in the pump communication circuit 12c to the main communication circuit 104.

Next, in S64, the pump controller 12a determines whether or not the duty cycle acquired in S62 is 50%. In a case where the duty cycle is 50% (YES in S64), the pump controller 12a drives the pump 12b at a predetermined rotational speed (for example, 10,000 rpm) in S66. Then, in S68, the pump controller 12a stores a current value of the pump 12b in the pump controller 12a.

In regard to the current value of the pump 12b, the current value becomes higher when a density of the purge gas is higher even when the pump 12b is being driven at the predetermined rotational speed. Since a density of the evaporated fuel is higher than a density of air, the density of the purge gas becomes higher when the purge concentration is higher, as a result of which the current value becomes higher. Since the current value fluctuates to a certain degree, the pump controller 12a acquires an average current value or a maximum current value and stores the same.

Next, in S70, the pump controller 12a determines a duty cycle to be sent to the controller 102 by using the current value stored in S68. Specifically, the pump controller 12a stores a current value-duty cycle data map 110 in advance. The current value-duty cycle data map 110 is specified by experiments in advance and is stored. The current value-duty cycle data map 110 indicates corresponding relationships between current values and duty cycles of PWM signal. Each of the current values is correlated to a purge concentration. Due to this, the duty cycles corresponding to the current values in the current value-duty cycle data map 110 correspond to the purge concentrations. These corresponding relationships between the duty cycles and the purge concentrations are indicated in the duty cycle-concentration data map 108. Due to this, the controller 102 can specify a purge concentration by using the duty cycle acquired from the pump controller 12a.

In S70, the pump controller 12a determines a duty cycle corresponding to the current value stored in S68 from the current value-duty cycle data map 110 and proceeds to S74.

On the other hand, in a case where the duty cycle is not 50% in S64 (NO in S64), the pump controller 12a erases in S72 the current value already stored in the pump controller 12a and proceeds to S74. In S74, the pump controller 12a supplies the pump communication circuit 12c with a duty cycle to be sent to the controller 102. Due to this, in S74 that takes place immediately after the processes of S68 and S70 have been performed, the duty cycle that was stored in S68 which had taken place immediately before is supplied, whereas in S74 that takes place immediately after the process of S72 has been performed, a duty cycle that was stored in the pump controller 12a in the last or previous concentration detecting process is supplied. Due to this, the pump controller 12a sends a PWM signal or the duty cycle stored in S74 to the main communication circuit 104.

Next, in S76, the pump controller 12a determines whether the duty cycle acquired in S62 is 55% (that is, whether or not a purge concentration is to be detected during the purge process). In a case where the duty cycle is not 55% (NO in S76), in S77, the pump controller 12a drives the pump 12b at a rotational speed corresponding to the duty cycle acquired in S62 in the rotational speed-duty cycle data map (see FIG. 2) and proceeds to S102.

On the other hand, in a case where the duty cycle acquired in S62 is 55% in S76 (YES in S76), the pump controller 12a drives the pump 12b at the predetermined rotational speed in S78, similar to S66. Then, in S80, the pump controller 12a acquires a current value of the pump 12b and stores the same in the pump controller 12a similar to S68. At this timepoint, two current values, namely the current value that was stored in the pump controller 12a before this S80 takes place (hereinbelow termed “previous current value”) and the current value that is stored in this S80 (hereinbelow termed “present current value”), are stored.

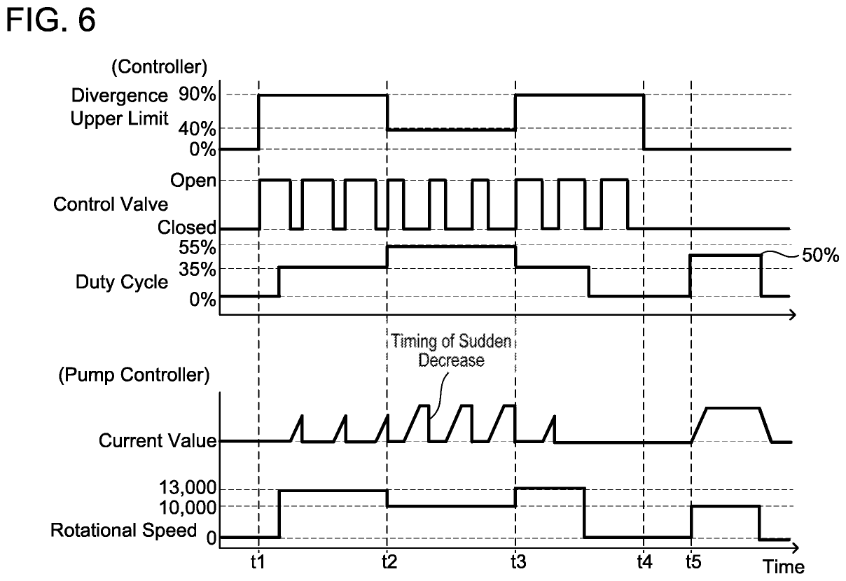

In subsequent S82, the pump controller 12a determines whether or not the current value has suddenly decreased. Specifically, the pump controller 12a determines whether or not the previous current value is larger than the present current value by a predetermined current value at minimum. The predetermined current value is set at a value that is somewhat smaller than a current difference exhibited at a timing of the sudden decrease shown in FIG. 6. During the purge process, the pressure in the purge passage 22a is increased while the control valve 34 in the closed state, by which a load on the pump 12b is increased. Due to this, the current value is increased in order to maintain the rotational speed of the pump 12b (see a period from timing 12 to timing t3 in FIG. 6). In order to suitably detect a purge concentration, it is desirable to acquire the current value of the pump 12b when it is stabilized at its maximum value. In S82, a timing when the current value suddenly decreased (see FIG. 6) is specified.

In a case where it is determined that the current value has decreased suddenly (YES in S82), the pump controller 12a sets a detection flag to on in S86 and proceeds to S98.

On the other hand, in a case where it is determined that the current value has not decreased suddenly (NO in S82), the pump controller 12a determines in S92 whether or not the present current value is less than the previous current value. In a case where the present current value is less than the previous current value (YES in S92), the pump controller 12a makes the present current value match the previous current value in S94 and proceeds to S96. On the other hand, in a case where the present current value is equal to or greater than the previous current value (NO in S92), the pump controller 12a skips S94 and proceeds to S96. In S96, the pump controller 12a sets the detection flag to off.

Next, in S98, the pump controller 12a determines whether or not the detection flag has been switched from off to on. Specifically, in a case where the process of S98 is performed immediately after the process of S86, the pump controller 12a determines that the detection flag has been switched from off to on (YES in S98). In the case of YES in S98, the pump controller 12a determines, in S100, a duty cycle corresponding to the previous current value stored in the pump controller 12a from the current value-duty cycle data map 110, similar to S70. Next, in S102, the pump controller 12a supplies the duty cycle to the pump communication circuit 12c, similar to S74. Then, in S104, the pump controller 12a makes the present current value match the previous current value and terminates the concentration detecting process. On the other hand, in a case of determining that the detection flag has not been switched from off to on (NO in S98), the pump controller 12a skips S100 and proceeds to S102. In S102 that takes place after S100 has been skipped, the pump controller 12a supplies the previously determined duty cycle to the pump communication circuit 12c. When terminating the concentration detecting process, the pump controller 12a erases the present current value. Thus, the pump controller 12a now stores the previous current value.

As shown in FIG. 6, when the purge condition is satisfied at timing t1, the controller 102 performs the switching control on the control valve 34. An upper limit of the divergence at this occasion is higher than the upper limit of the divergence set in S30 of FIG. 3. During the purge process, the controller 102 determines whether or not to drive the pump 12b based on the pressure in the intake manifold IM and the like. In a case of driving the pump 121% the controller 102 supplies a duty cycle corresponding to a desired rotational speed (35% in FIG. 6) to the main communication circuit 104. Due to this, the pump controller 12a acquires the duty cycle and drives the pump 12b at the rotational speed (13.000 rpm in FIG. 6) corresponding to the duty cycle (S77). Then, the current value of the pump 12b gradually increases. When the divergence of the control valve 34 is relatively high, the control valve 34 is switched from the closed state to the open state before the current value of the pump 12b stabilizes with the control valve 34 in the closed state.

At timing t2 after the second duration has elapsed from the timing t1 when the purge process was started (YES in S26), a PWM signal of the duty cycle 55%, which indicates that a purge concentration is to be detected during the purge process, is sent from the controller 102 to the pump controller 12a (S28). Then, the controller 102 sets the upper limit of the divergence of the control valve 34 (40% in FIG. 6) (S30). Due to this, the divergence of the control valve 34 is set to 40% if the divergence of the control valve 34 was equal to or greater than 40% before the timing t2, whereas the divergence of the control valve 34 is maintained as it is if the divergence of the control valve 34 was less than 40% before the timing t2.

As a result, the current value of the pump 12b gradually increases and stabilizes after the control valve 34 is switched from the open state to the closed state. Due to this, a purge concentration can be specified by using the current value of the pump 12b. At timing t3 when the detection of the purge concentration during the purge process is completed, the restriction on the upper limit of the divergence of the control valve 34 is released (S50), and the rotational speed of the pump 12b can be changed from the predetermined rotational speed.

The purge process is terminated at timing t4. At timing t5 when the first duration has elapsed (YES in S16), a PWM signal of the duty cycle 50%, which indicates that a purge concentration is to be detected during when the purge process is not performed, is sent from the controller 102 to the pump controller 12a (S18). Due to this, at timing t5, the pump 12b is driven at the predetermined rotational speed (S66). The pump controller 12a then acquires a pump current value (that is, a stabilized current value after the pump 12b was started to be driven) and sends a PWM signal of the duty cycle corresponding to the pump current value to the controller 102, as a result of which the controller 102 can acquire the purge concentration.

In the controller 102 and the pump controller 12a, the controller 102 requests the pump controller 12a to detect purge concentrations, by using the PWM signals with different duty cycles, during when the purge process is being performed and during when the purge process is not being performed, and the detection results of the purge concentrations are sent from the pump controller 12a to the controller 102. According to this configuration, communication according to a CAN standard or a LIN standard does not need to be performed between the controller 102 and the pump controller 12a. Due to this, circuit configurations of the pump controller 12a and the pump communication circuit 12c can be simplified.

Further, the controller 102 does not need to detect the purge concentration since the pump controller 12a detects the purge concentration. According to this configuration, the pump controller 12a does not need to send the acquired current value to the controller 102. As a result, the purge concentration can suitably be detected by using the current value that is stabilized in the brief duration during which the control valve 34 is in the closed state during the purge process.

### Second Embodiment

In the evaporated fuel processing device 10 according to the present embodiment, the controller 102 performs a determination acquiring process and the pump controller 12a performs a normality determining process, instead of the controller 102 performing the concentration acquiring process and the pump controller 12a performing the concentration detecting process.

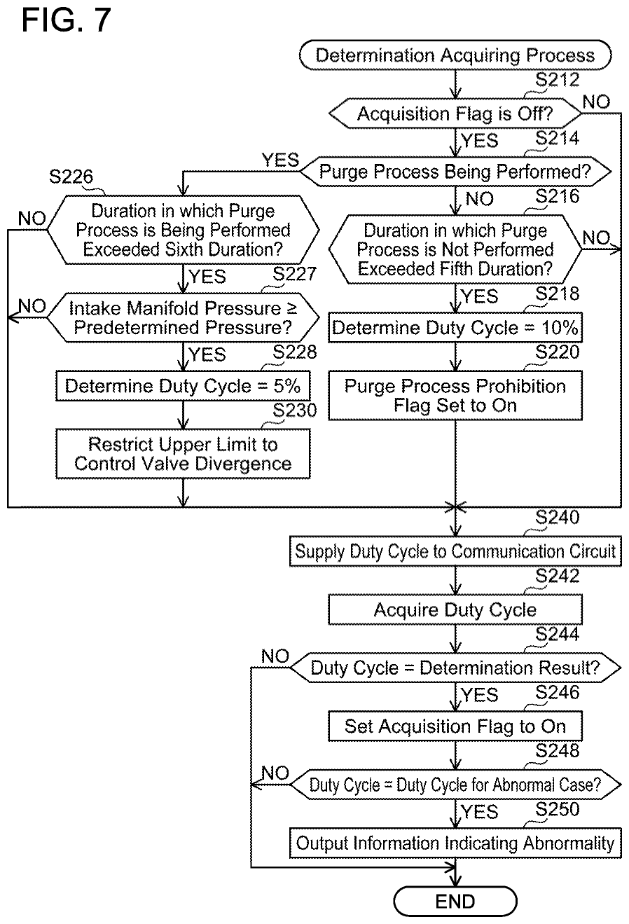

The controller 102 determines whether or not the pump 12b is being driven normally by using the pump module 12. FIG. 7 shows a flowchart of the determination acquiring process which the controller 102 performs. When the vehicle is started (for example, when the ignition switch is turned on), the controller 102 performs a normal acquiring process periodically (for example, every 16 ms). The controller 102 already stores an acquisition flag and a purge process prohibition flag to be used in the normal acquiring process. At the timing when the vehicle is started, the acquisition flag and the purge process prohibition flag are set to off.

In the normal acquiring process, the controller 102 firstly determines whether or not the acquisition flag is off in S212. In a case where the acquisition flag is on (NO in S212), the controller 102 proceeds to S240. On the other hand, in a case where the acquisition flag is off (YES in S212), the controller 102 determines in S214 whether or not the purge process is being performed, similar to S14 of FIG. 3. The controller 102 proceeds to S226 in a case of determining that the purge process is being performed (YES in S214), whereas it proceeds to S216 in a case of determining that the purge process is not performed (NO in S214).

In S216, the controller 102 determines whether or not a duration in which the purge process is not performed has exceeded a fifth duration (for example, 2500 ms). The fifth duration is a duration for the pressure in the purge passage 22 and the like to stabilize after the state in which the purge process is being performed is switched to the state in which it is not, similar to the first duration. The controller 102 includes a purge timer which is similar to that of the first embodiment. In a case where the duration in which the purge process is not performed has not exceeded the fifth duration (NO in S216), the controller 102 proceeds to S240.

On the other hand, in a case where the duration in which the purge process is not performed has exceeded the fifth duration (YES in S216), the controller 102 determines, in S218, a duty cycle of PWM signal to be sent to the pump controller 12a to be 10%. The PWM signal with the duty cycle 10% is a signal indicating that the determination on whether the pump 12b is being driven normally is to be made in the controller 102 and the pump controller 12a while the purge process is not performed. The duty cycle used here simply needs to be outside the range of the duty cycles that the controller 102 sends to the pump controller 12a for controlling the rotational speed of the pump 12b during the purge process. The same applies to a duty cycle in S228 to be described later and this duty cycle simply needs to differ from the duty cycle of S218.

Next, in S220, the controller 102 sets the purge prohibition flag from off to on and proceeds to S240. Due to this, when the purge prohibition flag is on, the controller 102 does not perform the purge process even if the purge condition is satisfied.

On the other hand, in S226, the controller 102 uses the purge timer to determine whether or not the duration in which the purge process is performed has exceeded a sixth duration (for example, 2000 ms). The sixth duration is a duration for the pressure in the purge passage 22 and the like to stabilize after the state in which the purge process is not performed is switched to the state in which it is being performed, similar to the second duration. In a case where the duration in which the purge process is performed has not exceeded the sixth duration (NO in S226), the controller 102 proceeds to S240.

On the other hand, in a case where the duration in which the purge process is being performed has exceeded the sixth duration (YES in S226), the controller 102 determines in S227 whether or not the pressure in the intake manifold IM is equal to or greater than a predetermined pressure (for example, 100 kPa). In a case where the pressure is equal to or greater than the predetermined pressure (YES in S227), the controller 102 determines, in S228, a duty cycle of PWM signal to be sent to the pump controller 12a to be 5%. Then, in S230, the controller 102 (more specifically, the valve controller 102a) sets an upper limit to the divergence of the control valve 34, similar to S30.

On the other hand, in a case where the pressure is less than the predetermined pressure in S227 (NO in S227), the controller 102 skips S228 and S230 and proceeds to S240.

In S240, the controller 102 supplies a duty cycle related to the rotational speed of the pump 12b to the main communication circuit 104. For example, in S240 that takes place immediately after the duty cycle had been determined in S218 or S228, the controller 102 supplies the duty cycle determined in S218 or S228 to the main communication circuit 104. On the other hand, in a case where neither S218 nor S228 was performed immediately before, the controller 102 supplies the duty cycle corresponding to the rotational speed of the pump 12b determined during the purge process to the main communication circuit 104. In the case where the purge process is not being performed, the pump 12b is not being driven. In this case, the controller 102 supplies the duty cycle corresponding to the rotational speed=0 to the main communication circuit 104.

Since the communication between the main communication circuit 104 and the pump communication circuit 12c is similar to that in the first embodiment, the description thereof will be omitted. When receiving a PWM signal sent from the pump communication circuit 12c, the main communication circuit 104 supplies the duty cycle of the received PWM signal to the controller 102.

Due to this, in S242, the controller 102 acquires the duty cycle from the main communication circuit 104. Then in S244, the controller 102 determines whether or not the duty cycle acquired in S242 indicates a normality determination result for the pump 12b. The controller 102 and the pump controller 12a both store a duty cycle for a case where the normality determination result for the pump 12b is normal (for example, 70%) and a duty cycle for a case where it is not normal (for example, 80%) in advance. These duty cycles simply need to be outside the range of duty cycles to be sent to the pump controller 12a for the controller 102 to control the rotational speed of the pump 12b. In a variant, a pulse width of the PWM signal may be used to indicate the normality determination result, instead of the duty cycle.

In a case where the duty cycle acquired in S242 matches one of the duty cycles indicating the normality determination result stored in the controller 102, the controller 102 determines that the duty cycle acquired in S242 indicates the normality determination result for the pump 12b (YES in S244) and proceeds to S246. On the other hand, in a case where the duty cycle acquired in S242 does not match either one of the duty cycles indicating the normality determination result stored in the controller 102, the controller 102 determines that the duty cycle acquired in S242 does not indicate the normality determination result for the pump 12b (NO in S244) and terminates the determination acquiring process.

In S246, the controller 102 sets the acquisition flag to on. Then, in S248, the controller 102 determines whether or not the duty cycle acquired in S242 matches the duty cycle for the case where the normality determination result for the pump 12b is not normal. In a case where the duty cycles match (YES in S248), the controller 102 outputs information indicating that the pump 12b is not being driven normally to a display device of the vehicle in S250 and terminates the determination acquiring process. When acquiring the information indicating that the pump 12b is not being driven normally, the display device of the vehicle displays this information. Due to this, a driver can be informed that the pump 12b is not being driven normally.

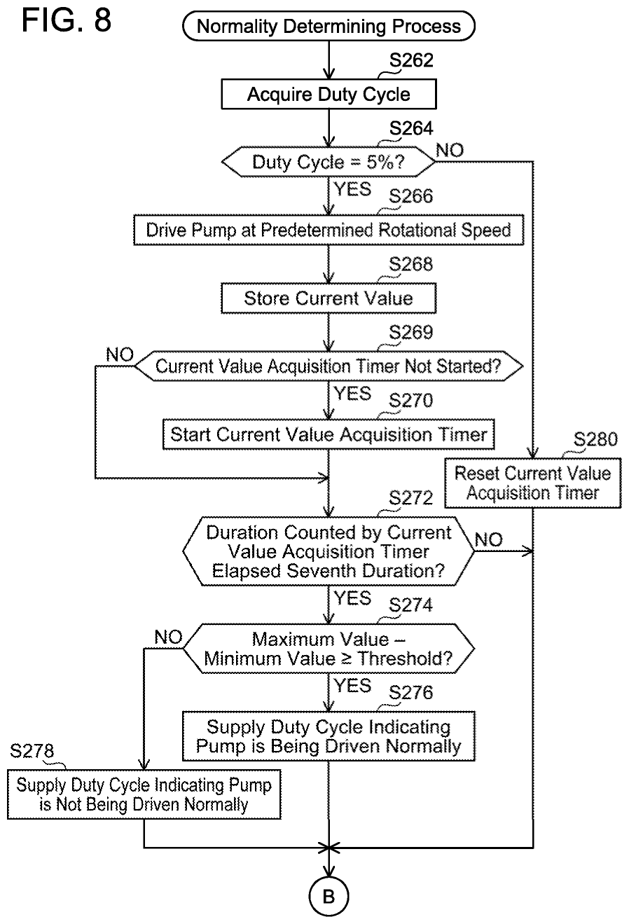

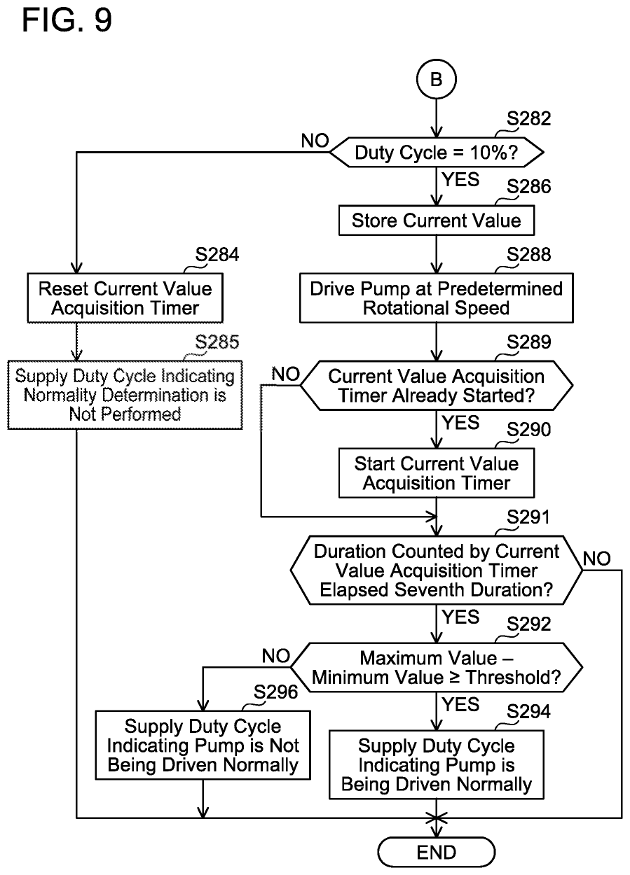

Next, the normality determining process which the pump controller 12a performs will be described with reference to FIGS. 8 and 9. When the vehicle is started, the pump controller 12a performs the normality determining process periodically (for example, every 2 ms). A frequency of the normality determining process is higher than a frequency of the determination acquiring process which the controller 102 performs.

In S262, the pump controller 12a acquires from the pump communication circuit 12c the duty cycle of the PWM signal sent from the controller 102 via the main communication circuit 104.

Next, in S264, the pump controller 12a determines whether or not the duty cycle acquired in S262 is 5%. In a case where the duty cycle is 5% (YES in S264), the pump controller 12a drives the pump 12b at the predetermined rotational speed (for example, 10,000 rpm) in S266. Then, in S268, the pump controller 12a stores a current value of the pump 12b in the pump controller 12a.

Next, in S269, the pump controller 12a determines whether or not a current value acquisition timer has been started. In a case of determining that the current value acquisition timer has not been started (YES in S269), the pump controller 12a starts the current value acquisition timer in S270 and proceeds to S272. On the other hand, in a case of determining that the current value acquisition timer has already been started (NO in S269), the pump controller 12a skips S270 and proceeds to S272.

In S272, the pump controller 12a determines whether or not a duration counted by the current value acquisition timer has elapsed a seventh duration. The seventh duration is a duration corresponding to the duration in which the purge process is performed. In a case where the duration counted by the current value acquisition timer has not elapsed the seventh duration (NO in S272), the pump controller 12a proceeds to S282. On the other hand, in a case where the duration counted by the current value acquisition timer has elapsed the seventh duration (YES in S272), the pump controller 12a determines in S274 whether a difference between a maximum value and a minimum value of the current values stored in the pump controller 12a is equal to or greater than a threshold. The threshold is a value for determining whether the current values have changed between when the control valve 34 is in the open state and when it is in the closed state.

In a case where the difference between the maximum value and the minimum value is equal to or greater than the threshold (YES in S274), the pump controller 12a supplies a duty cycle indicating that the pump 12b is being driven normally to the pump communication circuit 12c in S276 and proceeds to S282. On the other hand, in a case where the difference between the maximum value and the minimum value is less than the threshold (NO in S274), the pump controller 12a supplies a duty cycle indicating that the pump 12b is not being driven normally to the pump communication circuit 12c in S278 and proceeds to S282.

On the other hand, in a case of determining that the duty cycle is not 5% in S264 (NO in S264), the pump controller 12a resets the current acquisition timer in S280 and proceeds to S282.

Next in S282, the pump controller 12a determines whether or not the duty cycle acquired in S262 is 10% (that is, whether or not the normality determination is to be performed during when the purge process is not performed). In a case where the duty cycle is not 10% (NO in S282), the pump controller 12a resets the current value acquisition timer in S284. Then, in S285, the pump controller 12a supplies a duty cycle indicating that the normality determination on the pump 12b has not been performed to the pump communication circuit 12c and terminates the normality determining process.

On the other hand, in a case where the duty cycle is 10% (YES in S282), the pump controller 12a stores a current value of the pump 12b in S286. In the case where the pump 12b is not being driven, the current value of the pump 12b is 0 A. Next, in S288, the pump controller 12a drives the pump 12b at the predetermined rotational speed, similar to S266. If the pump 12b is already being driven at the predetermined rotational speed, the drive of the pump 12b is maintained. Then, the pump controller 12a performs processes of S289 to 5291, which are similar to S269 to S274.

In a case where a difference between the maximum value and the minimum value is equal to or greater than the threshold in S292 (YES in S292), the pump controller 12a supplies in S294 the duty cycle indicating that the pump 12b is being driven normally to the pump communication circuit 12c and terminates the normality determining process. On the other hand, in a case where the difference between the maximum value and the minimum value is less than the threshold (NO in S292), the pump controller 12a supplies in S296 the duty cycle indicating that the pump 12b is not being driven normally to the pump communication circuit 12c and terminates the normality determining process.

In the controller 102 and the pump controller 12a, the controller 102 requests the pump controller 12a to determine whether the pump 12b is being driven normally by using the PWM signals with different duty cycles, and the determination result is sent from the pump controller 12a to the controller 102. According to this configuration, the communication according to the CAN standard or the LIN standard does not need to be performed between the controller 102 and the pump controller 12a. Due to this, the circuit configurations of the pump controller 12a and the pump communication circuit 12c can be simplified.

Further, the controller 102 does not need to send the acquired current value to the controller 102 since the pump controller 12a performs the normality determination on the pump 12b. As a result, the normality determination can suitably be performed by using the current value that is stabilized in the brief duration in which the control valve 34 is in the closed state during the purge process.

While specific examples of the present disclosure have been described above in detail, these examples are merely illustrative and place no limitation on the scope of the patent claims. The technology described in the patent claims also encompasses various changes and modifications to the specific examples described above.

(1) In the first embodiment, the controller 102 performs the concentration acquiring process and the pump controller 12a performs the concentration detecting process. Further, in the second embodiment, the controller 102 performs the determination acquiring process and the pump controller 12a performs the normality determining process. However, the controller 102 may perform the determination acquiring process and the concentration acquiring process in parallel, and the pump controller 12a may perform the normality determining process and the concentration detecting process.

(2) In the above embodiments, the concentration acquiring process and the concentration detecting process, or the determination acquiring process and the normality determining process are performed by using the current values of the pump 12b. However, the concentration acquiring process and the concentration detecting process, or the determination acquiring process and the normality determining process may be performed by using the pressure in the purge passage 22 between the pump 12b and the control valve 34 or a difference between the pressure in the purge passage 22 on the upstream side relative to the pump 12b and the pressure in the purge passage 22 on the downstream side relative to the pump 12b.

(3) In the above embodiments, the purge passage 22 branches into the purge passages 24, 26. However, the purge passage 22 may not be branched, and may be connected with the purge passage 24 or the purge passage 26. In a case where the purge passage 22 is connected with the purge passage 26, the process of S227 may not be performed.

(4) Within the controller, a part that controls the control valve and other parts may be configured separately. In this case, the other parts of the controller may be configured integrally with the ECU 100.

(5) In the second embodiment, the purge concentration may be detected by a purge concentration detector disposed on the purge passage 24, for example.

(6) The ECU 100 and the pump controller 12a may perform the communication according to the CAN standard or the LIN standard instead of the communication using the PWM signals.

(7) In the first embodiment, the concentration acquiring process and the concentration detecting process are performed in both the case where the purge process is being performed and the case where the purge process is not performed. However, the concentration acquiring process and the concentration detecting process may be performed in one of the case where the purge process is being performed and the case where the purge process is not performed. In the second embodiment as well, similarly, the determination acquiring process and the normality determining process may be performed in one of the case where the purge process is being performed and the case where the purge process is not performed.

The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

### DESCRIPTION OF REFERENCE NUMBERS

2: Fuel supply system
10: Evaporated fuel processing device
12: Pump module
12a: Pump controller
12b: Pump
12c: Pump communication circuit
14: Canister
20: Evaporated fuel processing device
22: Purge passage
22a: Purge passage
24: Purge passage
26: Purge passage
32: Purge pipe
32a: Branching position
34: Control valve
50: Air-fuel ratio sensor
52: Air flowmeter
60: Pressure sensor
100: ECU
102: Controller
102a: Valve controller
104: Main communication circuit
108: Concentration data map
110: Duty cycle data map
AC: Air cleaner
AF: Air filter
CH: Supercharger
EN: Engine
EP: Exhaust pipe
FP: First purge passage
IM: Intake manifold
IP: Intake pipe
IW: Intake passage

1. A pump module mounted in an evaporated fuel processing device configured to perform a purge process in which evaporated fuel in a fuel tank is supplied to an intake passage of an engine through a purge passage, the pump module comprising:
a pump configured to pump the evaporated fuel in the purge passage to the intake passage; and
a pump controller configured to control drive of the pump,
wherein
the pump controller is communicably connected with a main controller configured to control the engine, and
the pump controller is configured to:
perform, by using a characteristic of the pump, at least one process of a concentration detecting process and a normality determining process, the concentration detecting process being a process of detecting a concentration of the evaporated fuel in gas within the pump, and the normality determining process being a process of determining whether the pump is being driven normally or not; and
send a process result of the at least one process to the main controller.

2. The pump module as in claim 1, wherein
the pump controller is configured to:
perform communication with the main controller by using a PWM signal based on pulse-width modulation;
in a case where a PWM signal having a first duty cycle is received from the main controller, drive the pump at a rotational speed corresponding to the first duty cycle, the first duty cycle being within a first range; and
in a case where a PWM signal having a second duty cycle is received from the main controller, drive the pump at a predetermined rotational speed and perform the at least one process, the second duty cycle being out of the first range.

3. The pump module as in claim 2, wherein
the pump controller is configured to send to the main controller a PWM signal having a duty cycle that indicates the process result.

4. An evaporated fuel processing device mounted in a vehicle, the evaporated fuel processing device comprising:
the pump module as in claim 1;
a canister configured to store evaporated fuel;
a control valve disposed on the purge passage communicating between the canister and the intake passage of the engine, and configured to switch between a closed state in which the purge passage is closed and an open state in which the purge passage is opened; and
a valve controller configured to control the control valve and communicably connected with the pump controller.

5. The evaporated fuel processing device as in claim 4, wherein
the valve controller is configured to:
perform the purge process by continuously switching the control valve between the closed state and the open state;
while the purge process is performed and the at least one process is not performed, switch the control valve with a ratio equal to or less than a first upper value, wherein the ratio is a ratio of a duration for one open state to a total duration for the one open state and one closed state;
while the purge process is performed and the at least one process is preformed, switch the control valve with a ratio equal to or less than a second upper value, wherein the ratio is a ratio of a duration for one open state to a total duration for the one open state and one closed state, and the second upper value is less than the first upper value, and
the pump controller is configured to perform the at least one process by using the characteristic of the pump while the control valve is in the closed state.

6. The evaporated fuel processing device as in claim 4, wherein
the valve controller is configured to prohibit switching the control valve to the closed state while the purge process is not performed, the closed state is maintained, and the at least one process is performed.
